(19) United States
(12) Patent Application Publication
(10) Pub. No.: US 2017/0131231 A1
(43) Pub. Date: May 11, 2017

(54) ELECTROCHEMICAL SENSOR AND MEASURING METHOD USING THE SAME

(71) Applicant: Kabushiki Kaisha Toshiba, Minato-ku (JP)

(72) Inventor: Kazuya MATSUZAWA, Kamakura (JP)

(73) Assignee: Kabushiki Kaisha Toshiba, Minato-ku (JP)

(21) Appl. No.: 15/415,565

(22) Filed: Jan. 25, 2017

Related U.S. Application Data
(63) Continuation of application No. PCT/JP2015/080138, filed on Oct. 26, 2015.

(30) Foreign Application Priority Data
Mar. 24, 2015 (JP) 2015-061795

(51) Int. Cl. G01N 27/414

(52) U.S. Cl. CPC G01N 27/4148

(57) ABSTRACT

An electrochemical sensor according to an embodiment includes a sensor unit, provided with a transistor including a first-conductivity type semiconductor layer, a second-conductivity type first conductive region provided in the semiconductor layer, a second-conductivity type second conductive region provided in the semiconductor layer, a first insulating film provided on the semi conductor layer between the first conductive region and the second conductive region, a charge storage film on the first insulating film, a second insulating film on the charge storage film, and a reference electrode, and a control circuit tor performing control based on a comparison result between a characteristic value measured by the sensor unit and a target value with respect to the characteristic value such that a predetermined voltage is applied between the semiconductor layer and the reference electrode.

### CROSS-REFERENCE TO RELATED APPLICATION

This application is continuation application of, and claims the benefit of priority from the International Application PCT/JP2015/080138, filed Oct. 26, 2015, which claims the benefit of priority from Japanese Patent Application No. 2015-61795, filed on Mar. 24, 2015, the entire contents of all of which are incorporated herein by reference.

### FIELD

Embodiments described herein relate generally to an electrochemical sensor and a measuring method using the same.

### BACKGROUND

For example, as an electrochemical sensor used for measurement of a pH value or measurement of a blood glucose level in the blood, there is an electrochemical sensor provided with an ion sensitive field effect transistor (hereinafter, “ISFET”) . ISFET is a semiconductor device in which a gate metal film of a so-called metal oxide semiconductor field effect transistor (MOSFET) is replaced by an ion-sensitive membrane to be in direct contact with a sample solution and a gate potential is provided from a reference electrode through the solution.

A characteristic value such as a threshold voltage of ISFET may be varied, for example, due to variation in ISFET manufacturing process. In addition, optimization of a characteristic value such as a threshold voltage of ISFET may be desired for each sample solution to be measured in order to ensure a measurement range. Therefore, an electrochemical sensor capable of adjusting a characteristic value such as a threshold voltage of ISFET is desired.

### BRIEF DESCRIPTION OF THE DRAWINGS

FIG. 1 is a block diagram of an electrochemical sensor according to a first embodiment;

FIG. 2 is a schematic diagram of ISFET according to the first embodiment;

FIG. 3 is a flowchart of a measuring method according to the first embodiment;

FIG. 4 illustrates functions and effects of the electrochemical sensor according to the first embodiment;

FIG. 5 is a block diagram of an electrochemical sensor according to a second embodiment; and

FIG. 6 is a block diagram of an electrochemical sensor according to a third embodiment.

### DETAILED DESCRIPTION

An electrochemical sensor according to an embodiment includes a sensor unit having a transistor, the transistor including a first-conductivity type semiconductor layer, a second-conductivity type first conductive region provided in the semiconductor layer, a second-conductivity type second conductive region provided in the semiconductor layer, a first insulating film provided on the semiconductor layer between the first conductive region and the second conductive region, a charge storage film on the first insulating film, a second insulating film on the charge storage film, and a reference electrode, and a control circuit controlling a voltage applied between the semiconductor layer and the reference electrode, the voltage being determined based on a comparison result between a characteristic value measured by the sensor unit and a target value associated with the characteristic value.

### First Embodiment

An electrochemical sensor according to the present embodiment includes a sensor unit provided with a field effect transistor including a first-conductivity type semiconductor layer, a second-conductivity type source region provided in the semiconductor layer, a second-conductivity type drain region provided in the semiconductor layer, a first insulating film provided on the semiconductor layer between the source region and the drain region, a charge storage film on the first insulating film, a second insulating film on the charge storage film, and a reference electrode, a memory for storing a target value of a characteristic value of the sensor unit, a comparison circuit for comparing the characteristic value measured by the sensor unit with the target value, a calculation circuit for calculating a voltage condition for injecting a charge into the charge storage film from a comparison result of the comparison circuit, and a control circuit for performing control so as to apply the voltage condition calculated by the calculation circuit between the semiconductor layer and the reference electrode.

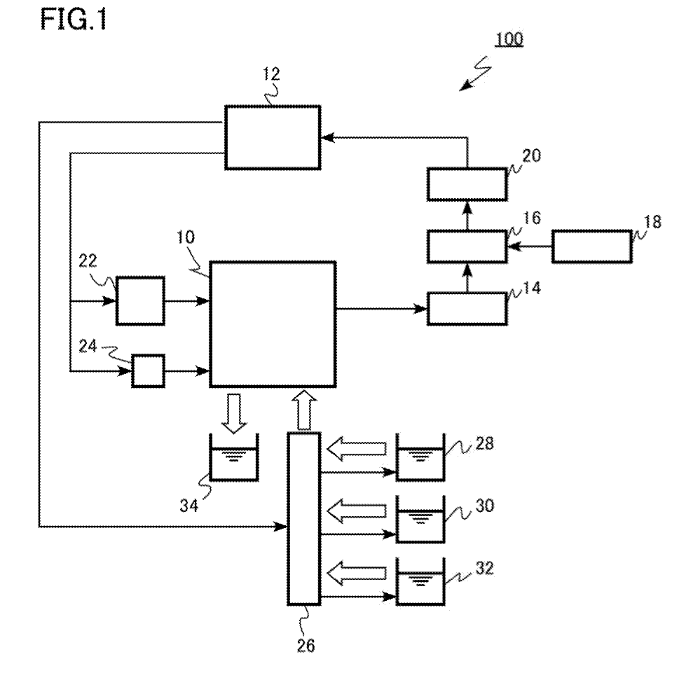

FIG. 1 is a block diagram of an electrochemical sensor according to the present embodiment. An electrochemical sensor 100 according to the present embodiment is a pH sensor.

The electrochemical sensor 100 according to the present embodiment includes a sensor unit 10, a control circuit 12, a detection circuit 14, a comparison circuit 16, a memory 18, a calculation circuit 20, a first boosting circuit 22, a first switching circuit 24, a chemical solution transfer mechanism 26, a first storage tank 28, a second storage tank 30, a third storage tank 32, and a waste tank 34.

The sensor unit 10 includes ISFET. A target material is introduced into the sensor unit 10. For example, by monitoring a voltage of ISFET, a pH value of the target material is measured. The electrochemical sensor 100 includes a mechanism for supplying the target material (not illustrated) to the sensor unit 10.

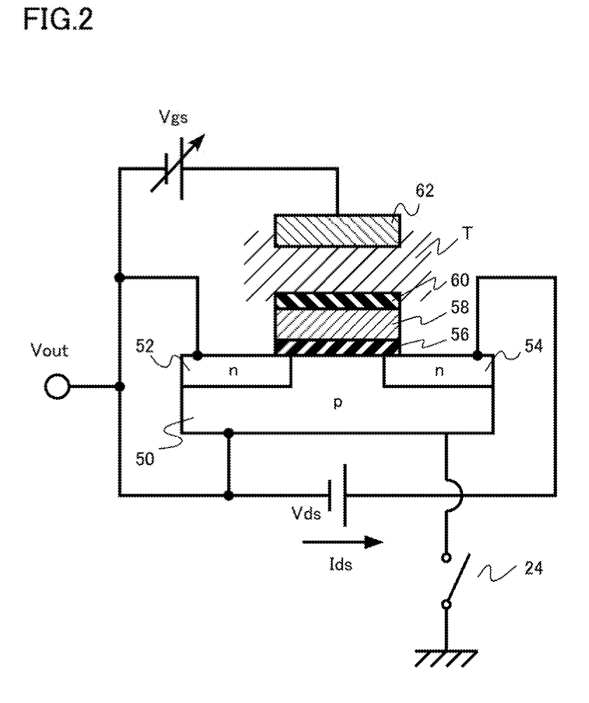

FIG. 2 is a schematic diagram of ISFET according to the present embodiment. ISFET includes a p-type semiconductor layer 50, an n-type source region (first conductive region) 52 provided in the semiconductor layer 50, an n-type drain region (second conductive region) 54 provided in the semiconductor layer 50, a first insulating film 56 on the semiconductor layer 50, a charge storage film 58 on the first insulating film 56, a second insulating film 60 on the charge storage film 58, and a reference electrode 62. ISFET according to the present embodiment is an n-channel type transistor.

The p-type semiconductor layer 50 is formed, for example, of single crystal silicon. Each of the n-type source region 52 and the n-type drain region 54 is, for example, a diffusion layer of n-type impurities. The first insulating film 56 is, for example, a silicon oxide film, a silicon nitride film, a silicon oxynitride film, or a stacked film thereof. The charge storage film 58 is, for example, a doped polycrystalline silicon film. The second insulating film 60 is, for example, a silicon nitride film, an aluminum oxide film, or a tantalum oxide film. The reference electrode 62 is formed of a metal such as silver, silver chloride, or platinum.

For example, a measurement electrolytic solution is retained between the second insulating film 60 and the reference electrode 62. A target material T is introduced into the measurement electrolytic solution.

ISFET has a source follower type circuit structure. When calibration is performed or the target material T is measured using an electrolytic solution, measurement is performed while the semiconductor layer 50 is in a floating state. For example, while Vds is maintained to a constant voltage and Vgs is adjusted so as to make Ids constant, a source voltage is monitored with an output terminal Vout.

In this case, the source voltage changes depending on a pH value of the electrolytic solution between the second insulating film 60 and the reference electrode 62. This source voltage is indicative of the pH value of the electrolytic solution between the second insulating film 60 and the reference electrode 62. Hereinafter, this voltage value is referred to as a pH instruction value. Hereinafter, a case where a characteristic value of ISFET is a pH instruction value will be exemplified.

A potential of the semiconductor layer 50 is switched between floating and a fixed potential by a first switching circuit 24.

ISFET according to the present embodiment can adjust a characteristic value such as a threshold voltage of ISFET or a pH instruction value of ISFET by injecting a charge into the charge storage film 58.

For example, the detection circuit 14 detects a source voltage output from the output terminal Vout of ISFET in the sensor unit 10 as a pH instruction value of ISFET. For example, the detection circuit 14 includes an amplifier circuit.

For example, the memory 18 stores a target value of a pH instruction value (characteristic value) measured by the sensor unit 10. For example, the memory 18 is a nonvolatile semiconductor memory.

For example, the comparison circuit 16 compares whether a pH instruction value measured by the sensor unit 10 is equal to a target value. For example, when the two values are not equal to each other, a difference between the two values is calculated.

The calculation circuit 20 calculates a voltage condition when a charge is injected into the charge storage film 58 of ISFET from the comparison result. Examples of the voltage condition include a voltage applied between the semiconductor layer 50 and the reference electrode 62, a direction of the voltage, and voltage application time. The voltage condition is calculated based on a state in which an adjustment electrolytic solution having a pH value of two or less or 12 or more is retained between the reference electrode 62 and the second insulating film 60.

The first boosting circuit 22 generates a first boosting voltage applied to the reference electrode 62.

The first switching circuit 24 switches a potential of the semiconductor layer 50 between a floating state and a fixed potential. When the target material T is measured, the potential of the semiconductor layer 50 is a floating state. When a charge is injected into the charge storage film 58, the potential of the semiconductor layer 50 is a fixed potential, fox example, is grounded.

For example, the first storage tank 28 stores an adjustment electrolytic solution for adjusting a characteristic of ISFET. The pH value of the adjustment electrolytic solution is two or less or 12 or more.

For example, the second storage tank 30 stores a measurement electrolytic solution used when the target material T is measured. For example, the pH value of the measurement electrolytic solution is more than two and less than 12.

For example, the third storage tank 32 stores a cleaning liquid for cleaning the sensor unit 10.

The waste tank 34 stores a chemical solution discharged from the sensor unit 10. The chemical solution transfer mechanism 26 transfers a chemical solution from the first storage tank 28, the second storage tank 30, and the third storage tank 32 to the sensor unit 10.

For example, the control circuit 12 controls the first boosting circuit 22 so as to apply a voltage condition calculated by the calculation circuit 20 between the semiconductor layer 50 and the reference electrode 62. For example, the control circuit 12 controls introduction of the adjustment electrolytic solution and the measurement electrolytic solution into the sensor unit 10, and discharge thereof.

Next, a measuring method using the electrochemical sensor according to the present embodiment will be described. The measuring method according to the present embodiment is a measuring method using an electrochemical sensor provided with a field effect transistor including a first-conductivity type semiconductor layer, a second-conductivity type source region provided in the semiconductor layer, a second-conductivity type drain region provided in the semiconductor layer, a first insulating film provided on the semiconductor layer between the source region and the drain region, a charge storage film on the first insulating film, a second insulating film on the charge storage film, and a reference electrode. A first characteristic value of the field effect transistor is measured while the semiconductor layer is in a floating state. An adjustment electrolytic solution having a pH of two or less or 12 or more is retained between the reference electrode and the second insulating film. A voltage is applied between the semiconductor layer and the reference electrode. A charge is injected into the charge storage film. The adjustment electrolytic solution is removed. A measurement electrolytic solution is retained between the reference electrode and the second insulating film. A target material is introduced into the measurement electrolytic solution. A second characteristic value of the field effect transistor is measured while the semiconductor layer is in a floating state.

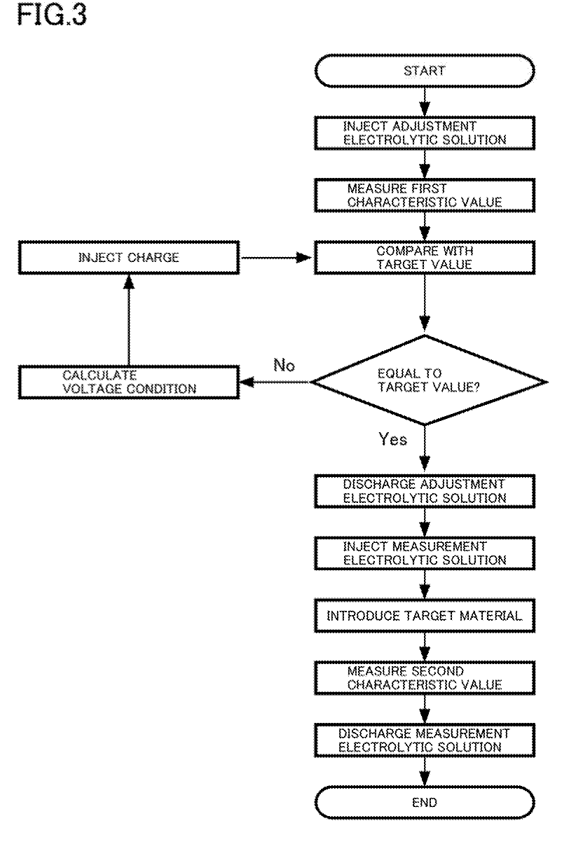

Hereinafter, a case where the characteristic value is a pH instruction value as described above will be exemplified. FIG. 3 is a flowchart of the measuring method according to the present embodiment.

First, an adjustment electrolytic solution having a pH value of two or less or 12 or more is retained between the reference electrode 62 of ISFET and the second insulating film 60 of ISFET illustrated in FIG. 2. The adjustment electrolytic solution is transferred from the first storage tank 28 to the sensor unit 10 by the chemical solution transfer mechanism 26.

Subsequently, a pH instruction value (first characteristic value) of ISFET is measured while the semiconductor layer 50 is in a floating state. The pH instruction value is detected by the detection circuit 14.

Subsequently, the comparison circuit 16 compares whether the detected pH instruction value is equal to a target value of the pH instruction value stored in the memory 18. The pH instruction value is associated with the detected pH instruction value.

When the detected pH instruction value is equal to the target value, the adjustment electrolytic solution is discharged from the sensor unit 10 to the waste tank 34.

Subsequently, a measurement electrolytic solution is introduced and retained between the reference electrode 62 and the second insulating film 60. The pH value of the measurement electrolytic solution is more than two and less than 12. By setting the pH value in this range, a measurement sensitivity of the pH value can be ensured. The pH value is desirably three or more and ten or less.

Subsequently, a target material is introduced into the measurement electrolytic solution.

Subsequently, a pH instruction value (second characteristic value) of ISFET is measured while the semiconductor layer 50 is in a floating state. The pH instruction value is detected by the detection circuit 14.

When the pH instruction value (second characteristic value) of ISFET is measured, a reference voltage is applied to the reference electrode 62 from the first boosting circuit 22. By setting the reference voltage to 10 V or less, the pH instruction value can be measured even when the pH value of the measurement electrolytic solution is any value in a range of more than two and less than 12.

Subsequently, the measurement electrolytic solution is discharged from the sensor unit 10 to the waste tank 34.

When the detected pH instruction value (first characteristic value) is not equal to the target value of the pH instruction value stored in the memory 18, the calculation circuit 20 calculates a voltage condition when a charge is injected into the charge storage film 58 of ISFET from the comparison result.

A charge is injected into the charge storage film 58 of ISFET under the calculated voltage condition. The calculated voltage condition is applied between the reference electrode 62 and the second insulating film 60. At this time, the potential of the semiconductor layer 50 is grounded by the first switching circuit 24.

After a charge is injected into the charge storage film 58 of ISFET, the first switching circuit 24 causes the semiconductor layer 50 to be in a floating state, a pH instruction value is measured, and the comparison circuit 16 compares whether the pH instruction value is equal to a target value of the pH instruction value.

Until the target value of the pH instruction value becomes equal to the measured pH instruction value, calculation of the voltage condition by the calculation circuit 20 and injection of a charge into the charge storage film 58 of ISFET are performed repeatedly.

Next, functions and effects of the electrochemical sensor according to the present embodiment will be described.

A characteristic value such as a threshold voltage of ISFET may be varied, for example, due to variation in ISFET manufacturing process. In addition, optimization of a characteristic value such as a threshold voltage of ISFET may be desired for each sample solution to be measured in order to ensure a measurement range.

The electrochemical sensor 100 according to the present embodiment can adjust a characteristic value of ISFET because ISFET of the sensor unit 10 includes the charge storage film 58.

For example, a positive voltage is applied between the reference electrode 62 and the semiconductor layer 50. An electron is injected from the semiconductor layer 50 into the charge storage film 58 due to a tunneling current flowing through the first insulating film 56. Writing of this electron increases a threshold voltage of n-channel type ISFET. For example, increase in the threshold voltage of the n-channel ISFET corresponds to increase in the pH instruction value.

By changing a condition for injecting a charge into the charge storage film 58, a characteristic value of ISFET such as a threshold voltage or a pH instruction value can be set to a desired target value.

Therefore, variation due to variation in ISFET manufacturing process can be corrected. In addition, optimization of a characteristic value such as a threshold voltage of ISFET can be performed for each sample solution to be measured in order to ensure a measurement range.

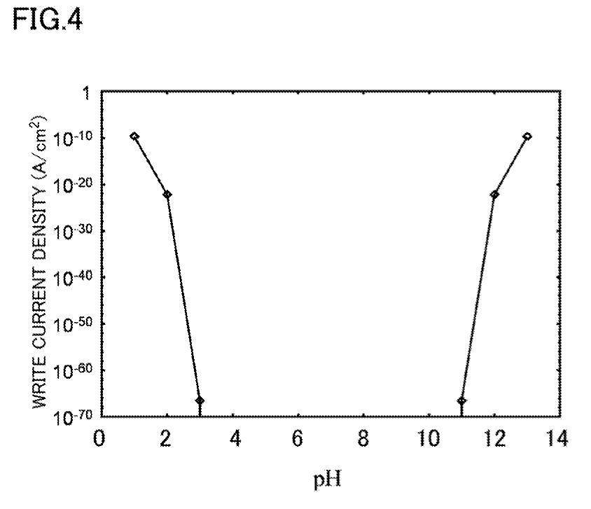

FIG. 4 illustrates functions and effects of the electrochemical sensor according to the present embodiment. Studies by the inventors have revealed that there is a severe restriction on a pH value of an electrolytic solution when a charge is injected into the charge storage film 58 with a tunneling current.

FIG. 4 illustrates a relationship between a write current density and a pH value of an electrolytic solution when a charge is injected into the charge storage film 58. As apparent from FIG. 4, the current density is large when the pH value is two or less or 12 or more, but the current density is extremely small and it is extremely difficult to inject a charge into the charge storage film 58 when the pH value is between two and 12.

It is considered that this is because a sufficient electric field is not applied to the first insulating film 56 due to consumption of the electric field in the electrolytic solution when the pH value is more than two and less than 12.

Therefore, in the present embodiment, an electrolytic solution having a pH value of two or less or 12 or more is used as an adjustment electrolytic solution when a charge is injected into the charge storage film 58.

Here, use of an adjustment electrolytic solution when a first characteristic value is measured has been exemplified. However, it is also possible to use an electrolytic solution having the same pH value as a measurement electrolytic solution when the first characteristic value is measured.

In addition, here, ISFET of a transistor in which the first-conductivity type is a p-type and the second-conductivity type is an n-type, that is, ISFET of an n-channel type transistor has been exemplified. However, it is also possible to use ISFET of a transistor in which the first-conductivity type is an n-type and the second-conductivity type is a p-type, that is, ISFET of a p-channel type transistor. A transistor only needs to be selected appropriately according to a target material.

From a viewpoint of ensuring a measurement range, an n-channel type transistor desirably uses an adjustment electrolytic solution having a pH value of two or less, and a p-channel type transistor desirably uses an adjustment electrolytic solution having a pH value of 12 or more.

The present embodiment realizes an electrochemical sensor capable of adjusting a characteristic value of ISFET and a measuring method using the same.

### Second Embodiment

An electrochemical sensor according to the present embodiment is similar to the first embodiment except further including a second switching circuit for switching a direction of a voltage between a semiconductor layer and a reference electrode when a charge is injected into a charge storage film, and a second boosting circuit for generating a second boosting voltage higher than a first boosting voltage applied between the semiconductor layer and the reference electrode when a charge is injected into the charge storage film. Therefore, description of contents overlapping with the first embodiment will be omitted.

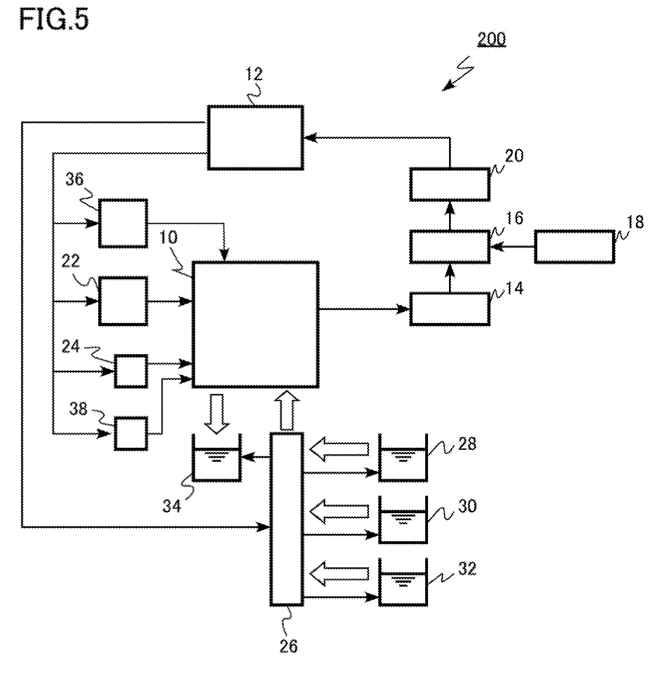

FIG. 5 is a block diagram of the electrochemical sensor according to the present embodiment. An electrochemical sensor 200 according to the present embodiment is a pH sensor.

The electrochemical sensor 200 according to the present embodiment includes a second switching circuit 38 and a second boosting circuit 36.

The second switching circuit 38 can switch a direction of a voltage between a semiconductor layer 50 and a reference electrode 62 when a charge is injected into a charge storage film 58. Therefore, an electron or a hole can be injected into the charge storage film 58. Therefore, a characteristic value of ISFET can be adjusted in a wide range. For example, a calculation circuit 20 determines the direction of a voltage.

In addition, the second boosting circuit 36 can generate a voltage (second boosting voltage) higher than a voltage (first boosting voltage) generated by a first boosting circuit 22. The voltage generated by the second boosting circuit 36 is applied between the reference electrode 62 and the semiconductor layer 50 before a charge is injected into the charge storage film 58. Therefore, a voltage when a charge is injected into the charge storage film 58 can be increased, and time for injecting a charge can be reduced. Therefore, a characteristic value of ISFET can be changed at a high speed.

### Third Embodiment

An electrochemical sensor according to the present embodiment is different from the first embodiment in that a sensor unit 10 has a cell array structure in which a plurality of ISFETs is disposed in an array. Description of contents overlapping with the first embodiment will be omitted.

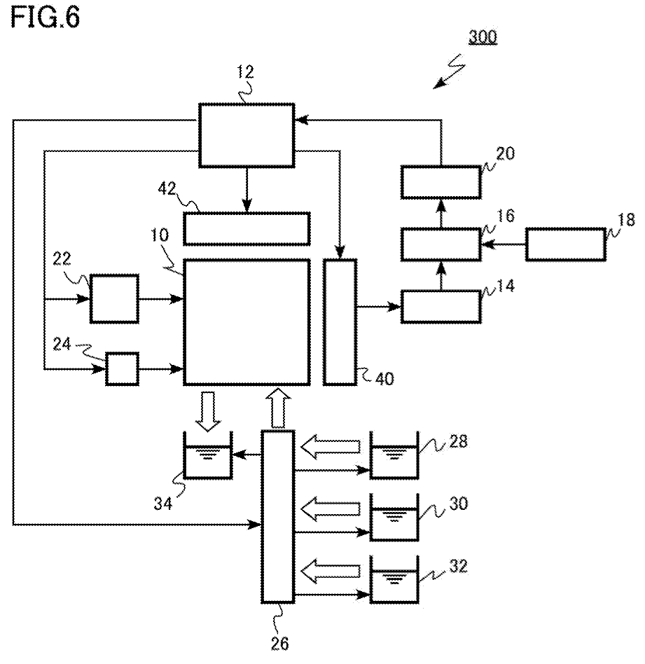

FIG. 6 is a block diagram of the electrochemical sensor according to the present embodiment. An electrochemical sensor 300 according to the present embodiment is a pH sensor.

The electrochemical sensor 300 according to the present embodiment has a cell array structure in which a plurality of ISFETs is disposed in an array in the sensor unit 10. The electrochemical sensor 300 includes a source selecting unit 40 and a drain selecting unit 42 for selecting a specific ISFET from the cell array. The source selecting unit 40 and the drain selecting unit 42 are controlled by a control circuit 12 to read a characteristic value of a specific ISFET and inject a charge into a specific ISFET.

The electrochemical sensor 300 according to the present embodiment can measure many target materials at the same time.

In the first to third embodiments, a case where an insulating film (second insulating film 60) is present on the charge storage film 58 has been exemplified. However, it is also possible to use a conductive film such as a mediator on the charge storage film 58.

In the first to third embodiments, fox example, constituent elements such as the sensor unit 10, the control circuit 12, the detection circuit 14, the comparison circuit 16, the calculation circuit 20, the first boosting circuit 22, the first switching circuit 24, the second boosting circuit 36, and the second switching circuit 38 can be realized by hardware or combination of hardware and software.

In the first to third embodiments, a pH sensor has been exemplified as an electrochemical sensor. However, the electrochemical sensor according to an embodiment of the present disclosure is not limited to the pH sensor. For example, the electrochemical sensor according to an embodiment of the present disclosure can be applied to various electrochemical sensors such as a blood glucose level sensor, an enzyme sensor, and a cell sensor.

While certain embodiments have been described, these embodiments have been presented by way of example only, and are not intended to limit the scope of the inventions. Indeed, the electrochemical sensor and the measuring method using the same described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. An electrochemical sensor comprising:
a sensor unit having a transistor, the transistor including a first-conductivity type semiconductor layer, a second-conductivity type first conductive region provided in the semiconductor layer, a second-conductivity type second conductive region provided in the semiconductor layer, a first insulating film provided on the semiconductor layer between the first conductive region and the second conductive region, a charge storage film on the first insulating film, a second insulating film on the charge storage film, and a reference electrode; and
a control circuit controlling a voltage applied between the semiconductor layer and the reference electrode, the voltage being determined based on a comparison result between a characteristic value measured by the sensor unit and a target value associated with the characteristic value.

2. The sensor according to claim 1, further comprising:
a memory storing the target value;
a comparison circuit comparing the characteristic value measured by the sensor unit with the target value; and
a calculation circuit calculating the voltage from the comparison result of the comparison circuit.

3. The sensor according to claim 2, wherein the voltage is calculated based on a state in which an adjustment electrolytic solution having a pH value of two or less or 12 or more is retained between the reference electrode and the second insulating film.

4. The sensor according to claim 1, further comprising a first boosting circuit generating a first coasting voltage applied to the reference electrode.

5. The sensor according to claim 1, further comprising a first switching circuit switching a potential of the semiconductor layer between a floating state and a fixed potential.

6. The sensor according to claim 1, further comprising a second switching circuit switching a direction of a voltage between the semiconductor layer and the reference electrode.

7. The sensor according to claim 4, further comprising a second boosting circuit generating a second boosting voltage higher than the first boosting voltage applied between the semiconductor layer and the reference electrode.

8. The sensor according to claim 1, further comprising:
a first storage tank storing an adjustment electrolytic solution having a pH value of two or less or 12 or more; and
a second storage tank storing a measurement electrolytic solution having a pH value of more than two and less than 12, wherein
the control circuit controls introduction of the adjustment electrolytic solution and the measurement electrolytic solution into the sensor unit, and discharge thereof.

9. A measuring method using an electrochemical sensor having a transistor including:
a first-conductivity type semiconductor layer;
a second-conductivity type first conductive region provided in the semiconductor layer;
a second-conductivity type second conductive region provided in the semiconductor layer;
a first insulating film provided on the semiconductor layer between the first conductive region and the second conductive region;
a charge storage film on the first insulating film;
a second insulating film on the charge storage film; and
a reference electrode, comprising:
measuring a first characteristic value of the transistor while the semiconductor layer is in a floating state;
retaining an adjustment electrolytic solution having a pH of two or less or 12 or more between the reference electrode and the second insulating film;
applying a voltage between the semiconductor layer and the reference electrode and injecting a charge into the charge storage film;
removing the adjustment electrolytic solution;
retaining a measurement electrolytic solution between the reference electrode and the second insulating film;
introducing a target material into the measurement electrolytic solution; and
measuring a second characteristic value of the transistor while the semiconductor layer is in a floating state.

10. The method according to claim 9, wherein the voltage when the charge is injected into the charge storage film is calculated from a comparison result obtained by comparing the first characteristic value with a target value after measurement of the first characteristic value.

11. The method according to claim 9, wherein the charge is injected into the charge storage film by applying the voltage between the reference electrode and the semiconductor layer, the voltage is higher than a voltage applied when the first characteristic value is measured.

12. The method according to claim 10, wherein a direction of the voltage between the semiconductor layer and the reference electrode when the charge is injected into the charge storage film is determined from the comparison result.

13. The method according to claim 9, wherein the adjustment electrolytic solution having a pH value of two or less is used when the first-conductivity type is a p-type, and the adjustment electrolytic solution having a pH value of 12 or more is used when the first-conductivity type is an n-type.

14. The method according to claim 9, wherein the pH value of the measurement electrolytic solution is more than two and less than 12.

15. The method according to claim 9, wherein the adjustment electrolytic solution is used when the first characteristic value is measured.

16. The method according to claim 9, wherein an electrolytic solution having the same pH value as the measurement electrolytic solution is used when the first characteristic value is measured.

17. The method according to claim 9, wherein the first characteristic value is a voltage value in the first conductive region.
